(19) United States
(12) Patent Application Publication
(10) Pub. No.: US 2005/0095111 A1
(43) Pub. Date: May 5, 2005

(54) Wafer transfer apparatus

(76) Inventors: Ki-Sang Kim, Yongin-Si (KR); Seung-Ki Chae, Seoul (KR); In-Ho Lee, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/936,478

(22) Filed: Sep. 9, 2004

(30) Foreign Application Priority Data
Oct. 29, 2003 (KR) 2003-76011

(51) Int. Cl. B66C 23/00

(52) U.S. Cl. 414/744.5

(57) ABSTRACT

A wafer transfer apparatus can transfer wafers to and from at least one process chamber quickly and in a small amount of space. The wafer transfer includes an arm unit, and a multi-blade connected to said arm unit so as to be rotatable relative to the arm unit. The multi-blade has at least two wafer supports configured to respectively support wafers as all lying in a horizontal plane. The arm unit includes a first arm mounted for rotation in a horizontal plane, and a second arm carried by the first arm and rotatable relative to the first arm in a horizontal plane. The multi-blade is carried by the second arm.

### BACKGROUND OF THE INVENTION

1. Field of the Invention

The present invention relates to a batch processing system in which workpieces, such as semiconductor wafers, are transferred to and from one or more processing chambers. More specifically, the present invention relates to a robot for transferring semiconductor wafers between a process chamber and a loadlock chamber.

2. Description of the Related Art

In general, a cluster system is a multi-chamber type of apparatus that includes a transfer robot (or handler) and a plurality of process modules disposed around the transfer robot. Today, there is an increasing demand for cluster systems that can execute a plurality of processes in the manufacturing of workpieces such as LCDs, PDPs and semiconductor devices.

An example of one such cluster system is disclosed in Japanese Patent Laid-Open Publication No. 10-275848. The cluster system has an octagonal housing defining a transfer chamber, and a transfer apparatus that is freely rotatable in the octagonal housing. A respective process module, such as a load lock chamber or a process chamber, is installed on each side of the transfer chamber. The transfer apparatus can remove a workpiece, such as a wafer, from a cassette in the load lock chamber, and place the wafer in a process chamber. Similarly, the transfer apparatus can remove the workpiece from the process chamber and transfer the processed workpiece to the next process module (load lock chamber or another process chamber).

However, this cluster system requires a large area to allow for the series of planar rotating operations performed by the horizontal arms of its transfer apparatus during wafer handling. That is, the transfer apparatus has a wide foot-print. Consequently, the overall area occupied by the facility is rather large. If this type of cluster apparatus were used in a mass production line, FAB maintenance costs would be high and it would be difficult to implement the logistics behind the automatic transfer of the workpieces. Also, the arms would have to be long enough to cover the relatively transfer distances required of the facility. This would, of course, be accompanied by long transfer times and the corresponding limits that such would impose on the productivity of the process.

Also, the transfer apparatus transfers only one wafer at a time. For example, the transfer apparatus removes a processed wafer from the process chamber, transfers the wafer to a load lock chamber (or other process chamber), and then grasps another wafer from the load lock chamber and places it in the process chamber. Such operations add significantly to the overall amount of time required to process the wafers in the system. Thus, such operations limit the production rate and add to the cost of the finished product.

### SUMMARY OF THE INVENTION

Accordingly, an object of the present invention is to provide a wafer or other workpiece transfer apparatus that substantially obviates one or more problems, limitations and disadvantages of the prior art.

More specifically, one object of the present invention to provide a wafer or other workpiece transfer apparatus that can minimize the time necessary to process a batch of the wafers.

It is another object of the present invention to provide a wafer transfer apparatus that can quickly exchange a processed wafer with an unprocessed wafer.

It is still another object of the present invention to provide a wafer transfer apparatus that can minimize the footprint of the processing system in which it is employed.

According to an aspect of the present invention, a wafer processing robot includes an arm actuator, a first arm supported by the arm actuator so as to be rotatable in a horizontal plane, a second arm supported by a front end of the first arm so as to be rotatable relative to the first arm in a horizontal plane, and a blade supported by a front end of the second arm so as to be rotatable relative to the second arm in a horizontal plane, wherein the blade includes at least two wafer (workpiece) supports by which at least two wafers (workpieces) can be supported at the same time while lying in the same plane.

The blade may comprise a fixing part at which the blade is connected to the front end of the second arm. In this case, a first wafer support is disposed to one side of the fixing part, and a second wafer support is disposed to the other side of the fixing part. Preferably, the first and second wafer supports are disposed symmetrically with respect to the fixing part. Alternatively, at least three wafer supports extend radially outwardly from the fixing part and are spaced from each other at equal intervals.

Each wafer support may be C-shaped so as to support the bottom of the wafer along its outer periphery. Alternatively, the wafer supports may each have the shape of a “-” (single longitudinally extending protrusion) to support the bottom of the wafer along a radially extending portion thereof.

According to another aspect of the present invention, the wafer transfer apparatus may further comprise a first joint part connecting the arm actuator with the first arm, a second joint part connecting the first arm with the second arm, a third joint part connecting the second arm with the blade, and timing pulleys and timing belts connecting the joint parts to the arm actuator such that each arm and the blade can be rotated by a predetermined angle via a respective one of the joint parts.

The arm actuator may comprise actuating devices, such as motors, that rotate the first arm, the second arm and the blade independently from one another via the joint parts, respectively. Alternatively, the first and second arms may each be rotated (articulated) by one actuating device. In this case, the blade is rotated independently of the arms by a separate actuating device.

According to yet another aspect of the present invention, the wafer/workpiece transfer apparatus is employed in a processing system for the batch processing of wafers/workpieces. The system includes at least one process chamber in which a workpiece is processed in a vacuum, and a load lock chamber connected to each process chamber. The arm unit of the transfer apparatus is disposed inside the load lock chamber, whereas the arm actuator is disposed outside the load lock chamber.

According to the processing system of the present invention, the first wafer/workpiece support can move into the process chamber and remove a wafer therefrom, and can quickly thereafter load a wafer/workpiece supported by the second wafer/workpiece support into the process chamber. That is, one wafer/workpiece support of the blade is used to load a wafer and the other wafer/workpiece support is used to unload a wafer in sequence, so that the loading and unloading operations can be performed consecutively in a short amount of time and within a small amount of space.

### BRIEF DESCRIPTION OF THE DRAWINGS

In the drawings:

FIG. 1 is a schematic plan view of a cluster system having a dual wafer transfer apparatus according to the present invention;

FIG. 2 is a perspective view, partially cut away, of the cluster system showing a dual wafer transfer apparatus of the system disposed within a load lock chamber;

FIG. 3 is a side view of the dual wafer transfer apparatus according to the present invention;

FIG. 4 is a cross-sectional view of the dual wafer transfer apparatus according to the present invention;

FIGS. 5 through 8 are schematic plan views of a wafer processing system according to the present invention, illustrating a process in which a wafer is loaded into a process chamber;

FIGS. 9 through 14 are schematic plan views of the wafer processing system, illustrating a process in which an unprocessed wafer is exchanged with a processed wafer;

FIG. 15 is a plan view of a blade having three wafer supports according to the present invention;

FIG. 16 is a plan view of another form of a blade of a dual wafer transfer apparatus according to the present invention; and

FIG. 17 is a cross-sectional view of another embodiment of a dual wafer transfer apparatus according to the present invention.

### DETAILED DESCRIPTION OF THE PREFERRED EMBODIMENTS

The preferred embodiments of the present invention will now be described in detail with reference to the accompanying drawings. However, note, the shapes of the components shown in the drawings are exaggerated for the sake of clarity. Also, wherever possible, the same reference numbers are used to designate the same or like parts throughout the drawings.

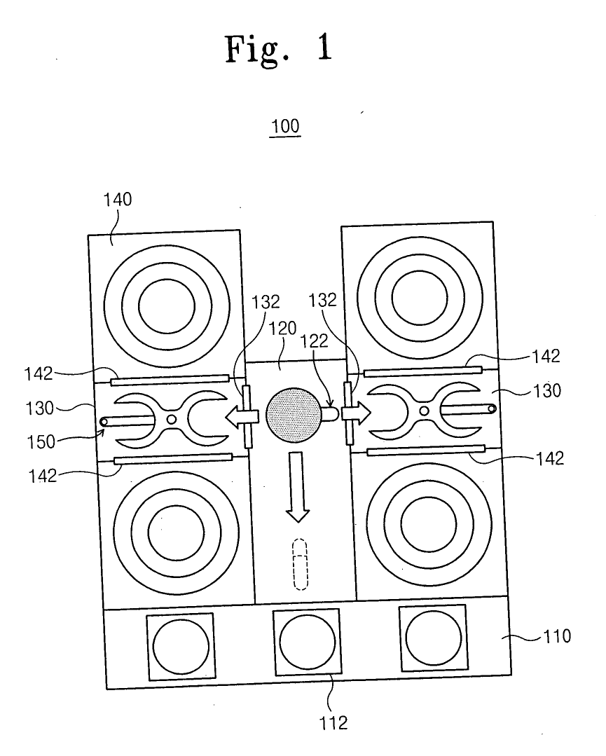

Referring to FIG. 1, a cluster system 100 includes an index station 110, a transfer passage 120, vacuum load lock chambers 130, dual wafer transfer apparatuses 150 and process chambers 140. The vacuum load lock chambers 130 are connected to both sides of the transfer passage 120. The dual wafer transfer apparatus 150 is installed in the vacuum load lock chamber 130. The process chambers 140 are connected to the vacuum load lock chambers 130. More specifically, two process chambers 140 are disposed at opposite sides of each load lock chamber 130.

The index station 110 accommodates foups 112 on which wafers are loaded. A foup is a known type of wafer carrier used throughout the industry for lot for production. The foups 112 are stably mounted to the index station 110 by an automated material handling system, e.g., an OHT, AGV, RGV. The index station 110 is connected to an end of the transfer passage 120. The index passage 120 is wide enough to facilitate the transfer of a wafer therealong.

The load lock chambers 130 are connected to opposite sides of the transfer passage 120, respectively. A single-wafer transfer apparatus 122 is installed in the transfer passage 120. The single-wafer transfer apparatus 122 can be any known general type of transfer apparatus that is operative to take a wafer out of a foup and transfer the wafer (in this case, to remove a wafer from a foup 112 mounted in the index station 110 and transfer the wafer to either load lock chamber 130). For instance, the wafer transfer apparatus may use an equipment front end module (EFEM) to transfer the wafers.

Each load lock chamber 130 is connected to a plurality of process chambers 140 such that the load lock chamber 130 can be shared by the process chambers 140. The load lock chambers 130 allow the wafers to be transferred between the transfer passage 120 and the process chambers 140 in such a way that the ultrahigh vacuum conditions of the process chambers 140 can be maintained. To this end, a vacuum system comprising a vacuum pump (not shown) is connected to the load lock chamber 130. The vacuum pump and its use with a load lock chamber are well known, per se, and thus a detailed description of the operation of the vacuum system will be omitted for the sake of brevity.

The dual wafer transfer apparatus 150 transfers wafers between the transfer passage 120 and the two process chambers 140. In this embodiment, two process chambers 140 are connected to each load lock chamber 130. However, the cluster system of the present invention can be configured so that three or more process chambers share each load lock chamber.

The process chambers 140 can constitute any of various wafer processing apparatus. For example, a process chamber 140 can constitute a CVD apparatus for depositing an insulating film on a wafer, an etch apparatus for etching a film on the wafer, a PVD apparatus for depositing a barrier film on a wafer, or a PVD apparatus for depositing a metal film on a wafer. The plurality of processing apparatus can perform all the processes necessary to completely manufacture an integrated circuit or a chip.

Each load lock chamber 130 has a first gate 132 that can be selectively opened and closed to allow a wafer to be moved in and out of the load lock chamber 132 between the chamber 130 and the transfer passage 120. Each process chamber 140 has a second gate 142 that can be selectively opened and allow a wafer to be moved in and out of the load lock chamber 132 between the chamber 130 and the process chamber 140. The gates 132 and 142 are constituted by the slots of a slit valve. Gates of this type are well known in the field and thus, a detailed description of the gates 132 and 142 will be omitted.

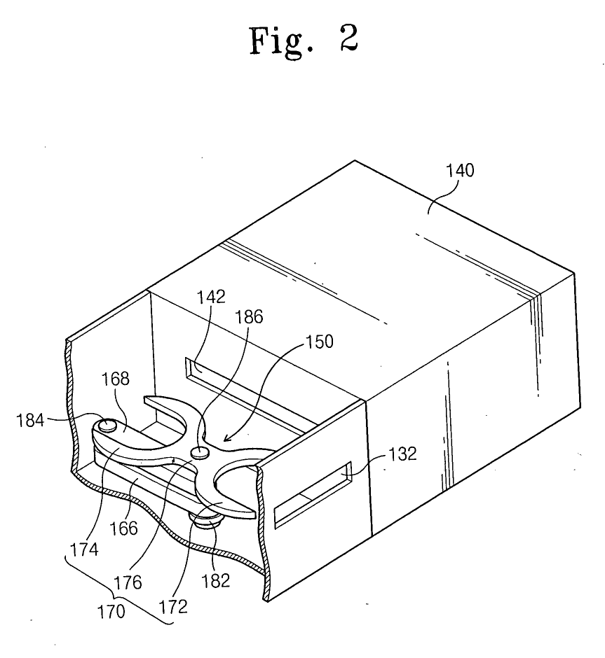

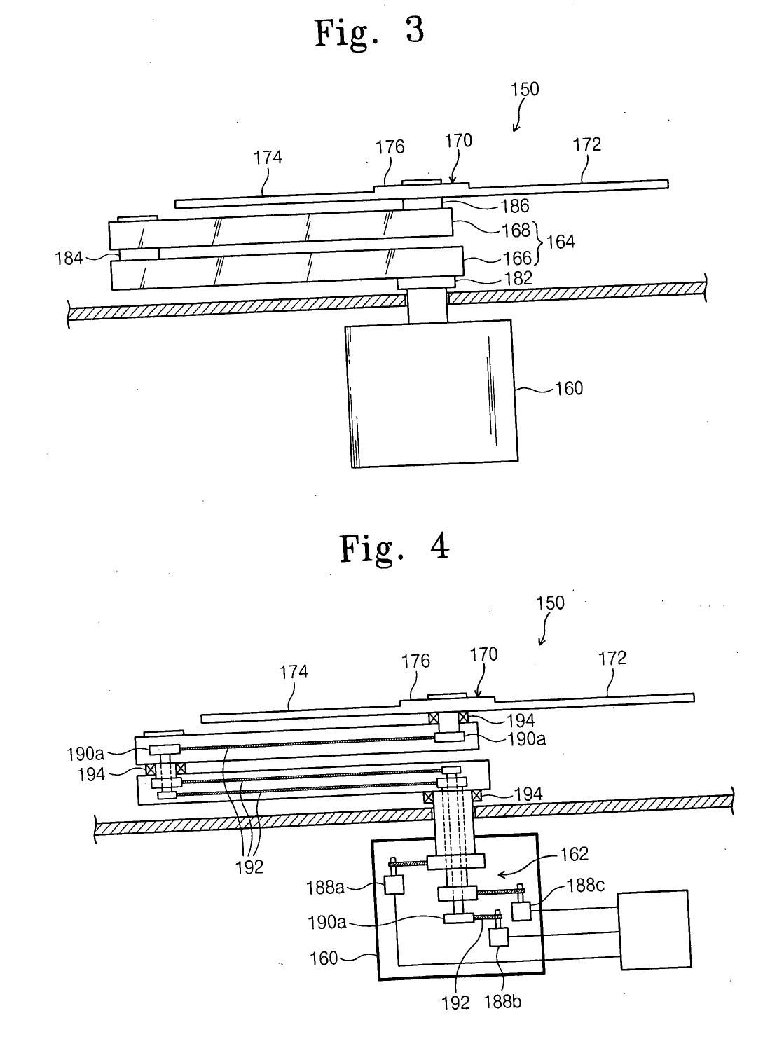

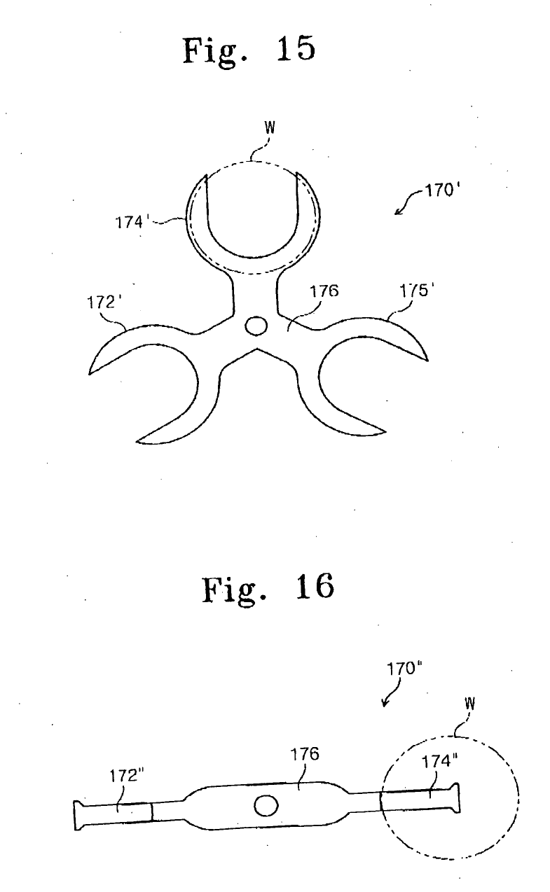

The dual wafer transfer apparatus 150 is installed in the load lock chamber 130. The dual wafer transfer apparatus 150 includes a dual blade 170 provided with two wafer supports 172, 174 that can load wafers into and unload wafers from the process chamber 140 consecutively. Note, although the blade of the dual wafer transfer apparatus is described and shown as having two wafer supports 172, 174, the present invention is not so limited. Rather, the blade 170 may comprise more than two wafer supports each configured to support a respective wafer. For example, as shown in FIG. 15, the blade 170′ may comprise three wafer supports 172′, 174′ and 175′ disposed symmetrically with respect to an axis of rotation of the blade. In any case, the dual wafer transfer apparatus 150 can transfer a wafer to and from two or more process chambers in a small space. The dual wafer transfer apparatus 150 will now be described in more detail with reference to FIGS. 2 to 4.

The dual wafer transfer apparatus 150 includes a base 160 and an arm unit 164 in addition to dual blade 170. The arm unit 164 includes a first arm 166 and a second arm 168. The base 160 supports the arm unit 164 and includes an arm actuator 162. The first and second arms 166 and 168 are connected to the arm actuator 162 via a first joint part 182 which allows the arms and blade to rotate together in horizontal planes about the rear end of the first arm 166. The second arm 168 is connected to the first arm 166 by a second joint part 184 that allows the second arm 168 to rotate in a horizontal plane relative to the first arm 166. The dual blade 170 is connected to a front end of the second arm 168 via a third joint part 184 that allows the blade to rotate in a horizontal plane relative to the arms.

Most importantly, though, the dual blade 170 includes a first wafer support 172 and a second wafer support 174 that support two wafers, respectively, in the same plane. The dual blade 170 (or blade 170′) also includes a fixing part 176 by which the dual blade is connected to the third joint part 186 by which the blade is connected to a third joint part. The first wafer support 172 and second wafer support 174 are located to both sides of the fixing part 176, respectively. Also, each wafer support is in the form of the letter “C” to support the bottom of a wafer along an outer peripheral portion thereof. A wafer chuck may also be installed on the blade of the dual wafer transfer apparatus 150 for securing the wafer to the blade. The wafer chuck may be a vacuum line through which a vacuum can be exerted on the wafer or a clamp for mechanically clamping an edge of a wafer to the blade.

On the other hand, the single-wafer transfer apparatus 122 has a blade in the form of a single protrusion, i.e., in the form of a “-”. Thus, the blade of the single-wafer transfer apparatus 122 can be received in the C-shaped blade of a dual wafer transfer apparatus 150 without interference when a wafer is transferred between the single-wafer transfer apparatus 122 and the dual wafer transfer apparatus 150. Obviously, the shapes of the blades of the single-wafer transfer apparatus 122 and dual wafer transfer apparatus 150 can be reversed, as shown in FIG. 16. In this case, the wafer support of the single-wafer transfer apparatus 122 is in the form of the letter “C” and the wafer supports 172″ and 174″ of the blade 170″ of the dual wafer transfer apparatus may each consist of an elongate protrusion (in the form of a “-”) so as to support the wafer along a radially extending part of the bottom of the wafer.

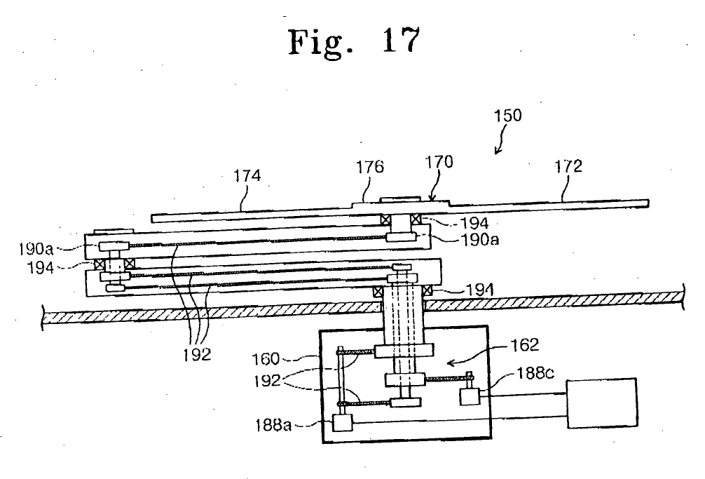

The first, second and third joint parts 182, 184 and 186 of the dual wafer transfer apparatus 150 are respectively controlled by driving motors 188a, 188b and 188c of the actuator disposed in the base 110. The joint parts 182, 184 and 186 are connected to the driving motors through a transmission mechanism. As an example, the transmission mechanism comprises one or more pulleys 190a and belts 192 connected to bearings 194. Preferably, the driving motors 188a, 188b and 188c are independently controllable to independently control the rotation of the first arm 166 about the rear end thereof, the second arm 168 about the rear end thereof, and the blade 170 about the fixing part 176 thereof. Note, although two driving motors are being shown and described as controlling the relative rotations of the first and second arms 166, 168, respectively, a single driving motor (1 88a) can be used to control the rotations of the first arm and second arms 166, 168, as shown in FIG. 17.

The first joint part 182 connects the base 110 with the first arm 166. The second joint part 184 connects the first arm 166 with the second arm 168. The third joint part 186 connects the second arm 168 with the blade 170. Each of the joint parts 182, 184 and 186 comprises a bearing 194 connected to the transmission mechanism such that each joint part receives power from a respective one of the driving motors 188a, 188b and 188c.

The driving motors 188a, 188b and 188c of the dual wafer transfer apparatus 150 are programmed, according to kinematic equations of the arm unit 164, to position the arms 166, 168 and blade 170 at desired locations. The program can be stored in a data memory device of a microprocessor (programmable controller) that provides signals for operating the driving motors 188a, 188b and 188c.

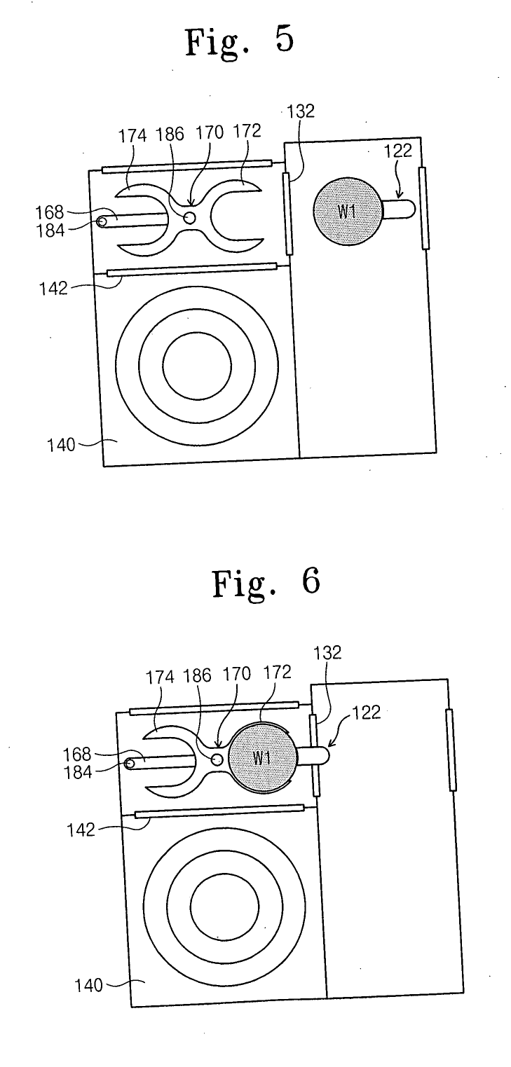

A process of transferring a wafer from a load lock chamber 130 to a process chamber 140 using a dual wafer transfer apparatus 150 will now be described with reference to FIGS. 5 through 8.

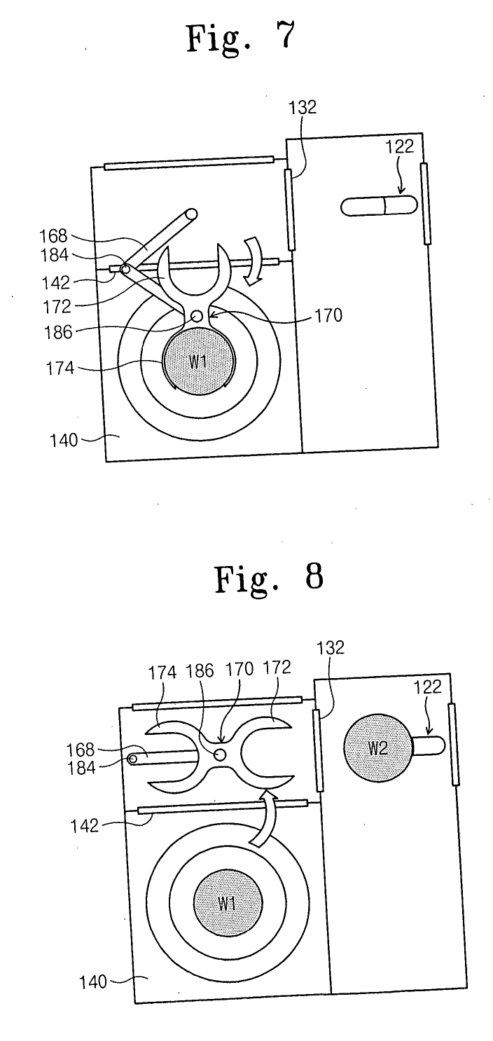

As shown in FIG. 5, the dual wafer transfer apparatus 150 starts from a fully folded position (standby position) in which the first arm 166, the second arm 168 and the blade 170 are all oriented in the same longitudinal direction in the load lock chamber 130 as juxtaposed one atop the other. Next, as shown in FIG. 6, a wafer WI is placed by the single-wafer transfer apparatus 122 on the first wafer support 172 located adjacent the first gate 132. Next, the arms 166, 176 are extended to the location shown in FIG. 7 and the blade 170 is rotated by a predetermined angle such that the dual wafer transfer apparatus 150 places the wafer W1 at a loading position in the process chamber 140. The wafer W1 can be lifted up off of the first wafer support 172 in the process chamber 140 by a wafer lifter (a known apparatus having three lift pins, but not shown in the drawings). The dual wafer transfer apparatus 150 is then returned to the load lock chamber 130, where it is placed in the standby position (folded position), as shown in FIG. 8. Finally, the wafer W1 is lowered by the wafer lifter onto a wafer stage or is otherwise positioned so as to be processed in the process chamber 140.

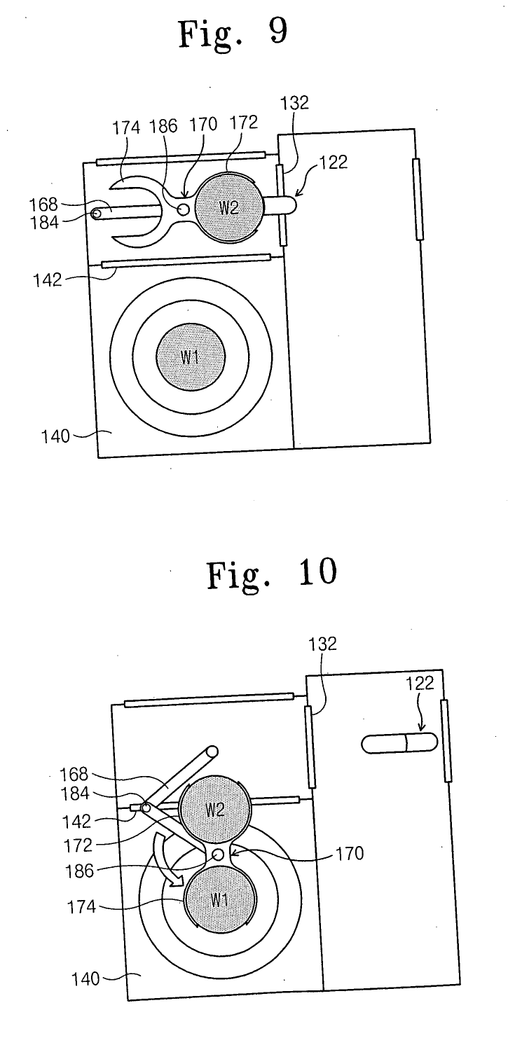

FIGS. 9 through 14 illustrate a process in which an unprocessed wafer W2 is exchanged with a processed wafer W1.

First, as shown in FIG. 9, the wafer W2 is transferred by the single-wafer transfer apparatus 122 onto the first wafer support 172 of the blade 170.

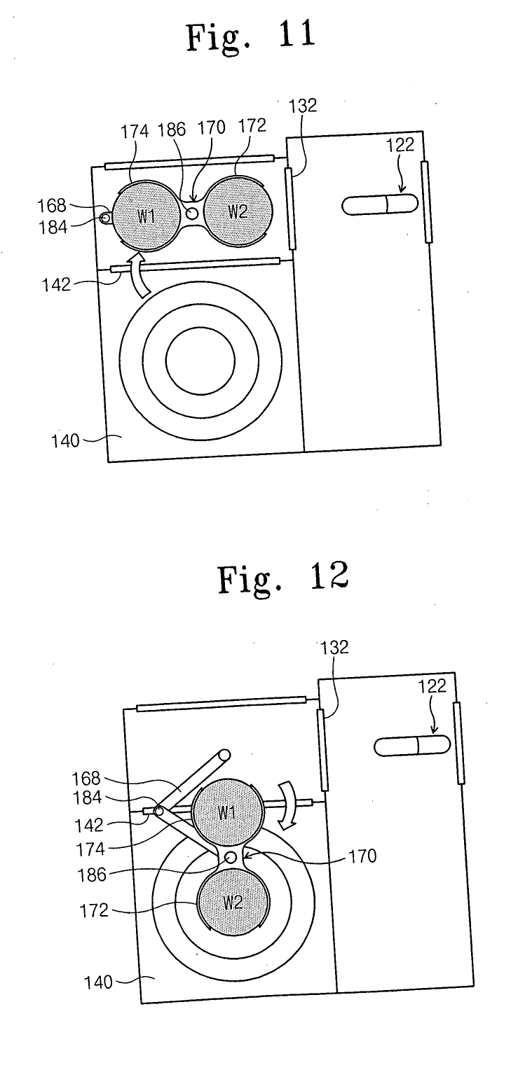

When the process is completed in the process chamber 140, the second gate 142 is opened and the second wafer support 174 of the dual blade 170 is extended through the second gate 142 to the location shown in FIG. 10. At this time, the processed wafer W1 is placed on the second wafer support 174 by the wafer lifter. Then, the dual wafer transfer apparatus 150 is returned to the standby position in the load lock chamber 130 (fully folded position), as shown in FIG. 11.

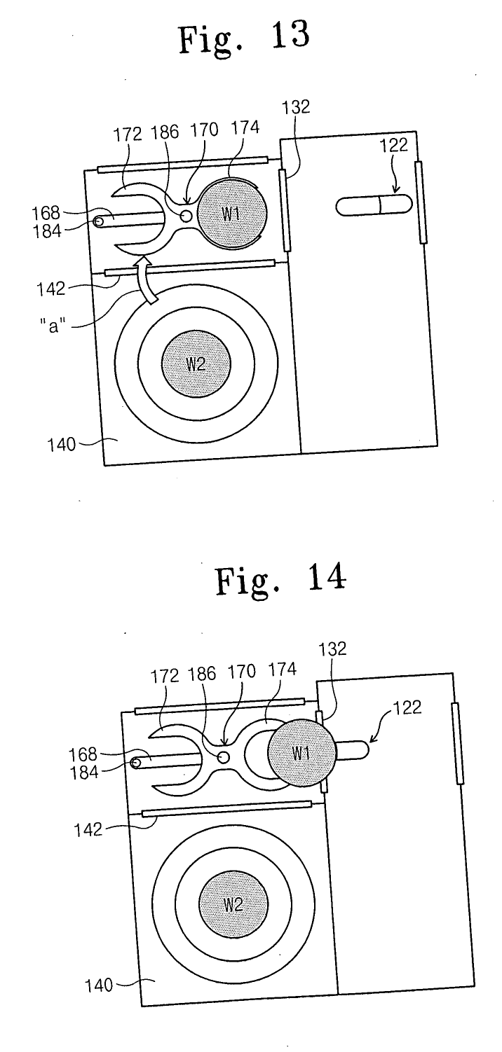

Next, the dual wafer transfer apparatus 150 extends the arms 166, 176 and rotates the blade 170 to insert the first wafer support 172 of the dual blade through the second gate 142 (to the location shown in FIG. 12) and thereby place the unprocessed wafer W2 at the loading position in the process chamber 140. At this time, the wafer can be lifted up off of the first wafer support 172 by the wafer lifter in the process chamber 140.

The dual wafer transfer apparatus 150 is then returned to the load lock chamber 130 outside the process chamber 140, and set in its standby position (fully folded position) as shown in FIG. 13. In this case, the arms are folded as before but the blade 170 is rotated in the direction of arrow (a) to position the second wafer support 174 adjacent the first gate 170. More specifically, the blade 170 is rotated 180° from the position shown in FIG. 11 such that the processed wafer W1 is now located adjacent the first gate 132. The processed wafer W1 is then transferred to the single-wafer transfer apparatus 122 through the first gate 132 (FIG. 14).

As described above, the wafer transfer apparatus of the present invention can optimize (minimize) the foot-print of a cluster system that can perform a plurality of processes in the batch manufacturing of LCDs, PDPs and semiconductor devices in general. Moreover, if the wafer transfer apparatus of the present invention is applied to a semiconductor wafer processing system, the semiconductor wafer process system can occupy a relatively small area and a high degree of cleanness can be maintained therein at a low cost. Also, the overall processing time can be reduced because a processed wafer can be exchanged with an unprocessed wafer in very little time.

Finally, various modifications and changes can be made to the present invention as will be apparent to those skilled in the art that. Thus, the true spirit and scope of the present invention encompasses all such changes and modifications that fall within the scope of the appended claims.

1. A workpiece transfer robot comprising:
a first arm having a front end and a rear end, and supported so as to be rotatable about said rear end thereof in a horizontal plane;
a second arm having a front end and a rear end, the rear end of said second arm being connected to the front end of said first arm such that the second arm is rotatable about the rear thereof relative to the first arm in a horizontal plane;
a blade connected to the front end of said second arm and supported thereby so as to be rotatable in a horizontal plane, said blade comprising at least two discrete workpiece supports configured to support at least two workpieces, respectively, in orientations in which the workpieces lie directly across from each other in a horizontal plane; and
an arm actuator supporting said first arm at said rear end thereof, operatively connected to said first and second arms so as to rotate said arms about the rear ends thereof, respectively, and operatively connected to said blade so as to rotate so blade relative to said second arm.

2. The robot of claim 1, wherein said blade comprises a fixing part at which the blade is connected to the front end of said second arm, and said workpiece supports comprise a first workpiece support disposed to one side of the fixing part, and a second workpiece support disposed to the other side of said fixing part, said first and second workpiece supports being disposed symmetrically with respect to the fixing part.

3. The robot of claim 1, wherein said blade comprises a fixing part at which the blade is connected to the front end of said second arm, and said workpiece supports comprise at least three workpiece supports extending radially from and disposed symmetrically with respect to the fixing part.

4. The robot of claim 2, wherein each of said workpiece supports is C-shaped so as to support a semiconductor wafer along the outer peripheral part of the bottom of the wafer.

5. The robot of claim 1, wherein each of said workpiece supports consists of an elongate protrusion so as to support a semiconductor wafer along a radially extending part of the bottom of the wafer.

6. The robot of claim 2, wherein each of said workpiece supports is C-shaped so as to support a semiconductor wafer along the outer peripheral part of the bottom of the wafer.

7. The robot of claim 1, wherein said arm actuator comprises at least one motor connected to said first and second arms, and another motor connected to said blade independently of the at least one motor connected to said first and second arms.

8. The robot of claim 1, and further comprising a first joint part rotatably supporting the first arm at said rear end thereof, a second joint part connecting the rear end of said second arm to the front end of said first arm and rotatably supporting the second arm at said rear end thereof, a third joint part connecting said blade and the front end of said second arm and rotatably supporting said blade at the front end of said second arm, and timing pulleys timing belts connecting said arm actuator to said joint parts.

9. The robot of claim 7, and further comprising a first joint part rotatably supporting the first arm at said rear end thereof, a second joint part connecting the rear end of said second arm to the front end of said first arm and rotatably supporting the second arm at said rear end thereof, a third joint part connecting said blade and the front end of said second arm and rotatably supporting said blade at the front end of said second arm, and timing pulleys timing belts connecting said arm actuator to said joint parts.

10. The robot of claim 7, wherein said arm actuator comprises respective motors connected to said first and second arms.

11. The robot of claim 7, wherein said arm actuator comprises one motor connected to both said first and said second arms.

12. A processing system for the batch processing of workpieces, said system comprising:
at least one process chamber in which a workpiece is processed in a vacuum;
a load lock chamber connected to each said at least one process chamber; and
a robot comprising an arm unit disposed inside said load lock chamber,
a blade connected to and supported by said arm unit so as to be rotatable relative to said arm unit, the blade including at least two workpiece supports configured to support at least two workpieces, respectively, in orientations in which the workpieces lie directly across from each other in a horizontal plane, and
an arm actuator disposed outside said load lock chamber, the arm actuator including at least one first actuating device operatively connected to said arm unit so as to move said arm unit between a first standby position in which said arm unit and said blade are located entirely within said load lock chamber and a second loading position at which said blade is located in said process chamber, and a second actuating device operatively connected to said blade so as to rotate said blade relative to said arm unit in a horizontal plane.

13. The system of claim 8, wherein each of said workpiece supports of the blade of said robot is C-shaped so as to support a semiconductor wafer along the outer peripheral part of the bottom of the wafer.

14. The system of claim 8, wherein each of said workpiece supports of the blade of said robot consists of an elongate protrusion so as to support a semiconductor wafer along a radially extending part of the bottom of the wafer.

15. The system of claim 13, and further comprising a transfer passage connected to said load lock chamber, and a single-wafer transfer apparatus disposed in said passage, said single-wafer transfer apparatus comprising a blade having the form of an elongate protrusion that is insertable into each of the C-shaped wafer supports of the blade of said robot without contacting the same.

16. The system of claim 14, and further comprising a transfer passage connected to said load lock chamber, and a single-wafer transfer apparatus disposed in said passage, said single-wafer transfer apparatus comprising a C-shaped blade into which each of the wafer supports of the blade of said robot can be respectively inserted without contacting the same.

17. The system of claim 12, wherein said arm unit comprises a first arm having a front end and a rear end, and supported so as to be rotatable about said rear end thereof in a horizontal plane, and a second arm having a front end and a rear end, the rear end of said second arm being connected to the front end of said first arm such that the second arm is rotatable about the rear thereof relative to the first arm in a horizontal plane.

18. The system of claim 17, wherein said blade of the robot comprises a fixing part at which the blade is connected to the front end of said second arm, and said workpiece supports comprise a first workpiece support disposed to one side of the fixing part, and a second workpiece support disposed to the other side of said fixing part, said first and second workpiece supports being disposed symmetrically with respect to the fixing part.

19. The system of claim 17, wherein said at least one first actuating device of the robot comprises at least one motor connected to said first and second arms, and said second actuating device of the robot comprises another motor connected to said blade independently of the at least one motor connected to said first and second arms.

20. The system of claim 17, wherein said robot further comprises a first joint part rotatably supporting the first arm at said rear end thereof, a second joint part connecting the rear end of said second arm to the front end of said first arm and rotatably supporting the second arm at said rear end thereof, a third joint part connecting said blade and the front end of said second arm and rotatably supporting said blade at the front end of said second arm, and timing pulleys timing belts connecting said actuating devices to said joint parts.
